(19) United States
(12) Patent Application Publication
(10) Pub. No.: US 2020/0299807 A1
(43) Pub. Date: Sep. 24, 2020

(54) Bearing Alloy, Sliding Member, Internal Combustion Engine, And Motor Vehicle

(71) Applicant: TAIHO KOGYO CO., LTD., Toyota-Shi (JP)

(72) Inventor: Hayato KODAMA, Toyota-Shi (JP)

(21) Appl. No.: 16/800,171

(22) Filed: Feb. 25, 2020

(30) Foreign Application Priority Data
Mar. 22, 2019 (JP) 2019-054362

(51) Int. Cl. C22C 9/02; F16C 33/12

(52) U.S. Cl. CPC C22C 9/02; F16C 2204/12; F16C 33/121; F16C 33/125

(57) ABSTRACT

A bearing alloy according to one embodiment includes 5.5 to 10 mass % of Sn; 2 to 7 mass % of Ni; 1 to 5 mass % of Bi; 0 to 0.3 mass % of Ag; and the balance consists essentially of Cu and unavoidable impurities.

### TECHNICAL FIELD

The present invention relates to a bearing alloy, a sliding member, an internal combustion engine, and a motor vehicle.

### RELATED ART

Patent Document 1 describes a Cu-based bearing alloy in which a primary Ag phase is dispersed in a Bi phase in order to improve seizure resistance. Patent Document 2 discloses a Cu-based bearing alloy having a structure in which an intermetallic compound is in contact with the Pb phase and/or the Bi phase around the Pb phase and/or the Bi phase in order to improve seizure resistance and fatigue resistance while reducing the Pb content.

### PRIOR-ART

### Patent Document

Patent Document 1: Japanese Patent Application Laid-Open No. 2014-196524

Patent Document 2 Japanese Patent No. 3507388

### SUMMARY

### Problem to be Solved

In the bearing alloy described in Patent Document 1, there is room for improvement in fatigue resistance and seizure resistance. In addition, the bearing alloy described in Patent Document 2 contains Pb, and there is a concern that the bearing alloy may adversely affect the environment.

In contrast, the present invention provides a sliding member using a Pb-free material and improved seizure resistance, and an alloy for the sliding member therefor.

### Solution

The present invention provides an alloy for a sliding member comprising from 5.5 to 10 mass % of Sn, from 2 to 7 mass % of Ni, from 1 to 5 mass % of Bi, from 0 to 0.3 mass % of Ag, with the balance substantially consisting of Cu and unavoidable impurities.

The area ratio of the Ni—Sn intermetallic compound in the cross section may be 0.4% or more.

In a cross section, Bi grains with an area greater than or equal to 30 μm² and Bi grains with an area less than or equal to 5 μm² may coexist.

The ratio of the number of Bi grains having the area of 5 μm or less to the number of all Bi grains observed in the cross section may be 50% or more.

In the cross section, in a region having a radius of 25 μm from the center of Bi grains having an area of 30 μm or more, the ratio of the number of Bi grains having an area of 5 μm² or less to the number of the total number of Bi grains in the region may be 50% or more.

The present invention also provides a sliding member having a lining layer formed of the alloy for a sliding member according to any one of the above, and a resin coating layer or a metal plating layer formed on the lining layer.

Further, the present invention provides an internal combustion engine having the above-mentioned sliding member.

The present invention further provides a motor vehicle having the above-mentioned internal combustion engine.

### Effect of the Invention

According to the present invention, it is possible to provide a sliding member having improved seizure resistance while suppressing a decrease in fatigue resistance by using a Pb-free material, and an alloy for the sliding member therefor.

### BRIEF DESCRIPTION OF THE DRAWINGS

FIG. 1 shows an external appearance of a thrust sliding member according to an embodiment.

FIG. 2 is an example of a cross-sectional photograph of an alloy for a sliding member according to an embodiment.

FIG. 3 shows a schematic view of a cross-sectional structure of an alloy for a sliding member.

FIG. 4 shows effects of Sn and Ni on the characteristics of the alloy.

FIG. 5 is a flowchart illustrating a method of manufacturing a sliding member according to an embodiment.

FIG. 6 is a graph showing the relationship between the area ratio of the Ni—Sn phase and the abrasion depth.

FIG. 7 is a graph showing the relationship between the area ratio of the Ni—Sn phase and the frictional coefficient.

### DETAILED DESCRIPTION

### 1. Composition

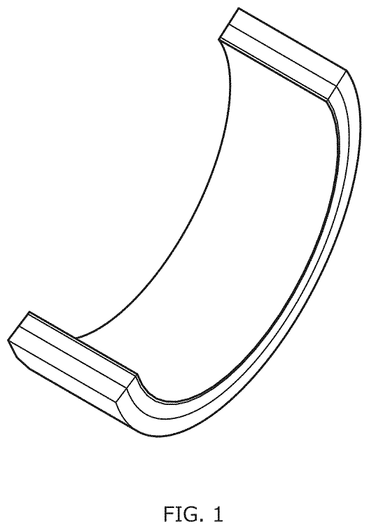

FIG. 1 shows an external appearance of a sliding member according to an embodiment. Here, a half bearing is illustrated as an example of a sliding member. The sliding member includes a layer formed of an alloy for the sliding member according to an embodiment. The alloy for the sliding member is a Cu-based alloy (copper alloy). The Cu-based alloy is a so-called Cu—Sn—Ni—Bi—Ag alloy and includes (A) Sn, (B) Ni, (C) Bi, and (D) Ag. The remainder is composed of Cu and unavoidable impurities. The unavoidable impurities include, for example, at least one of Al, Fe, Mg, Ti, B, Pb, and Cr. The unavoidable impurities are incorporated, for example, in smelting or scrap. The content of unavoidable impurities is, for example, 1.0 mass % or less in total amount.

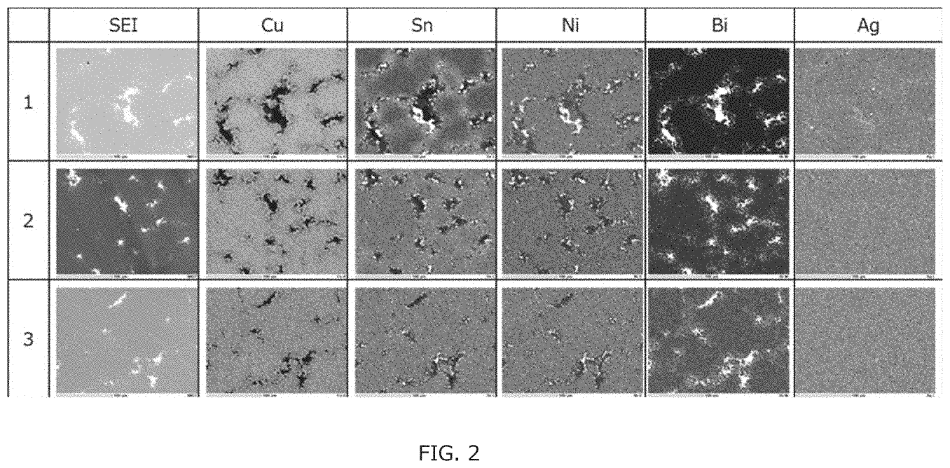

FIG. 2 is an example of a cross-sectional photograph of an alloy for a sliding member according to an embodiment. These images are ×500 images obtained by SEM-EDX (using JSM-6610A manufactured by Nippon Electronics Co., Ltd.). The image at the left of the figure is a secondary electron image (SEI), and the distribution of Cu, Sn, Ni, Bi, and Ag elements is shown in this order from left to right. From these figures, it can be seen that Sn and Ni are divided into a solid solution in Cu and an intermetallic compound of Ni—Sn. The composition of the sample in this photograph is as follows. Other components are not included or are unavoidable impurities.

TABLE 1

| | Cu | Sn | Ni | Bi | Ag |
|---|---|---|---|---|---|
| Sample 1 | Bal. | 8.5 | 3.0 | 4.2 | 0.19 |
| Sample 2 | Bal. | 6.6 | 4.6 | 3.1 | 0.11 |
| Sample 3 | Bal. | 5.4 | 6 | 2.1 | 0.02 |

in mass %

The content of each component is preferably as follows.

(A) Sn: 5 to 10 mass %. More preferably, the content is 5 to 8.5 mass %.

(B) Ni: 2 to 7 mass %. It is more preferable that the content is 3 to 6 mass %.

(C) Bi: 1 to 5 mass %. It is more preferable that the content is 2 to 4.5 mass %.

(D) Ag: 0 to 0.3 mass %. It is more preferable that the content is 0.01 to 0.2 mass %. Here, 5 to 10 mass % means 5 mass % or more and 10 mass % or less.

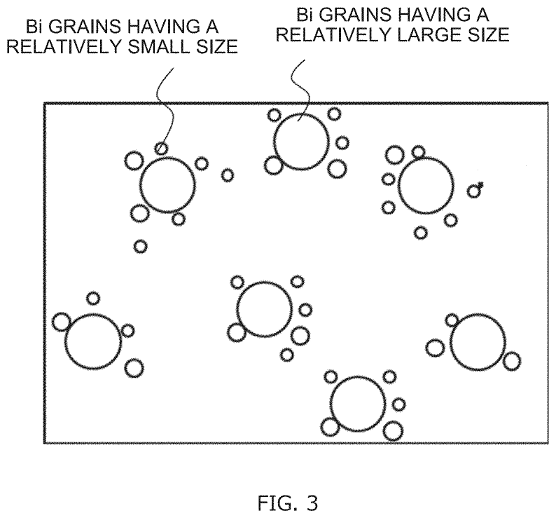

FIG. 3 shows a schematic diagram of a cross-sectional structure of an alloy for a sliding member. In the cross-sectional structure of the alloy for a sliding member, Bi grains having a relatively large size (specifically, an area of 30 μm or more ²) and Bi grains having a relatively small size (specifically, an area of 5 μm or less ²) coexist (or are mixed). Specifically, the ratio of the number of small Bi grains to the total number of Bi grains observed on the observation surface (150 μm in length×250 μm in width) is 50% or more, and preferably 60% or more.

Table 2 shows the results of measurement of the ratio of the number of small Bi grains for Samples 1 to 3. For the measurement, the same apparatus as that used for the image analysis in the experimental example described later was used. Sample 4 is a comparative example, and the composition thereof is Cu-4Sn-6.5Bi.

TABLE 2

| | Ratio (%) of | Ratio (%) of | Ratio (%) of |
|---|---|---|---|
| | small Bi grain | middle Bi grain | large Bi grain |
| | (less than 5 μm²) | (5 to 30 μm²) | (more than 30 μm²) |
| Sample 1 | 62.3 | 22.3 | 15.3 |
| Sample 2 | 85.0 | 10.0 | 5.0 |
| Sample 3 | 68.6 | 21.1 | 10.3 |
| Sample 4 | 38.5 | 22.2 | 39.3 |

As can be seen from the results, in each of Samples 1 to 3, the proportion of Bi grains smaller than that in Sample 4, which is a comparative example, was higher, 40% or more, and in detail, 60% or more. The proportion of large Bi grains was 30% or less, more specifically 20% or less, and even 16% or less. The area of the Bi grains in this measurement is calculated by image analysis software, which calculation will be described later.

In addition, from another viewpoint, the small Bi grains are distributed in many areas around the large Bi grains. Specifically, in an area having a radius of 25 μm from the center of the large Bi grains, the ratio occupied by the small Bi grains is 50% or more on average, and is preferably 60% or more.

Table 3 shows the results of measuring the ratio of the number of Bi grains in an area having a radius of 25 μm from the center of the large Bi grains for Samples 1 to 4. For the measurement, the same apparatus as that used for the image analysis in the experimental example described later was used. Although a plurality of large Bi grains exist in the observation region, an area having a radius of 25 μm was set for each of the large Bi grains, and the results were averaged for all the large Bi grains after the Bi grains in the area were measured.

TABLE 3

| | Ratio (%) of | Ratio (%) of | Ratio (%) of |
|---|---|---|---|
| | small Bi grain | middle Bi grain | large Bi grain |
| | (less than 5 μm²) | (5 to 30 μm²) | (more than 30 μm²) |
| | in the area | in the area | in the area |
| Sample 1 | 69.3 | 13.1 | 17.6 |
| Sample 2 | 84.7 | 7.3 | 8.0 |
| Sample 3 | 68.1 | 18.7 | 13.3 |
| Sample 4 | 31.3 | 24.7 | 44.0 |

As can be seen from the results, in each of Samples 1 to 3, the proportion of Bi grains smaller than that in Sample 4, which is a comparative example, was higher, 40% or more, and more specifically, 60% or more. The proportion of large Bi grains was 30% or less, more specifically 20% or less, and further 18% or less. Further, in contrast to the results shown in Table 2, the ratio of the number of medium Bi grains in the area is smaller than the ratio of the number of medium Bi grains in the entire observation region. Conversely, the ratio of the number of large Bi grains in the area is greater than the ratio of the number of large Bi grains in the entire observation region.

Bi is a soft and self-lubricating material. The distribution of Bi grains having a small diameter as well as Bi grains having a large diameter expands the range of contact with Bi grains on the opposite shaft, resulting in lower friction compared to a case in which only Bi grains having a large diameter exist. The low friction provides the effects of improved seizure resistance and improved wear resistance. Since Bi is soft, the strength of the entire material may be lowered. However, as compared with the example in which only large granular Bi is distributed, the reduction in strength of the entire material is smaller when large granular Bi and small granular Bi are mixed. When this material is used for a sliding member, for example, a bearing, an effect of suppressing reduction in fatigue resistance can be obtained.

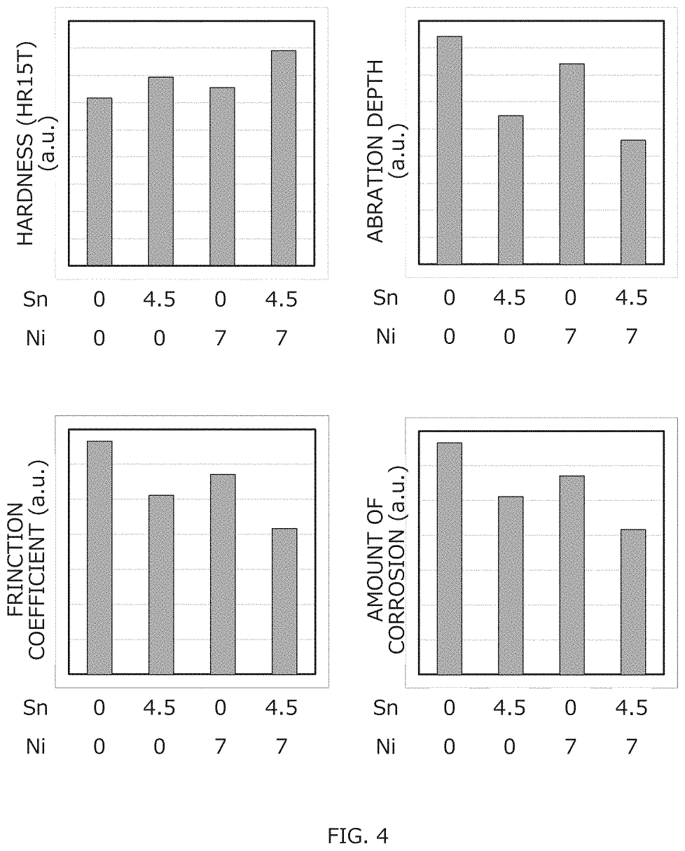

FIG. 4 is a diagram showing the influence of Sn and Ni on the characteristics of the alloy. Here, the content of Sn was 0 mass % or 4.5 mass %, and the content of Ni was 0 mass % or 7 mass %. Compositions other than Sn and Ni were 3 mass % of Bi, 0.07 mass % of Ag, and the balance was Cu. With respect to the coefficient of friction, the amount of wear, the amount of corrosion, and the Rockwell hardness, the characteristics were improved in the example including at least one of Sn and Ni as compared with the example including no Sn or Ni. In particular, examples containing both Sn and Ni showed further improvement in properties compared to examples containing only either Sn or Ni. With respect to the friction coefficient, the wear amount, the corrosion amount, and the hardness, the improvement effect was higher in the example containing only Sn than in the example containing only Ni.

### 2. Manufacturing Method

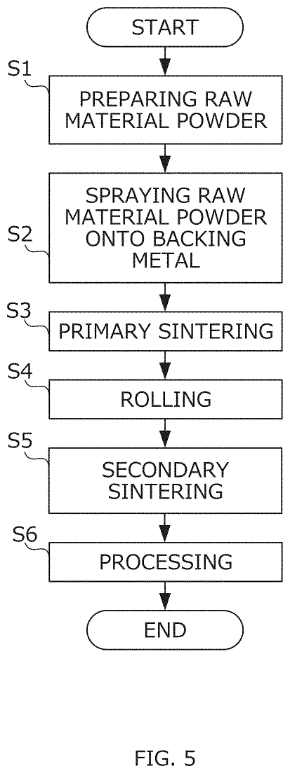

FIG. 5 is a flowchart illustrating a method of manufacturing a sliding member using an alloy for a sliding member according to an embodiment. In step S1, a raw material powder of a copper alloy is prepared. In this embodiment, Cu—Sn—Ni—Bi—Ag alloy powder is used. In addition to or instead of this, a mixture of elemental metal powders may be used. In step S2, the raw material powder is sprayed onto the backing metal. In step S3, primary sintering is performed. The primary sintering is carried out under conditions of a temperature of 850° C. and a retention time of 10 minutes in a hydrogen reduction atmosphere. After primary sintering, rolling (step S4) is performed, followed by secondary sintering (step S5). The secondary sintering is carried out under the same conditions as those of the primary sintering. The workpiece after the secondary sintering has a belt shape, and is wound up, for example, on a roll and subjected to the next step. In step S6, the alloy material is processed into a desired shape to obtain a sliding member.

The sliding member thus obtained is, for example, a half bearing. This half bearing is used, for example, as a so-called main bearing in an internal combustion engine of a motor vehicle. In addition, in the related art, there is an example in which a Cu-based alloy containing In is used as an alloy for a sliding member, but In has a relatively high cost, and there have been cases in which cost has become a problem. However, since the alloy for a sliding member according to the present embodiment does not contain In in the component (In-free), the cost can be kept low as compared with the example in which In is contained.

### 3. Embodiment

The inventors of the present application produced specimens of sliding members under various conditions, and evaluated the wear resistance and the coefficient of friction of these specimens. First, the compositions of the alloys used in the produced test pieces and the area ratio of the Ni—Sn phase (Ni—Sn intermetallic compound phase) in the cross-sectional structure are as shown in Table 4. The area ratio of the Ni—Sn phase in the cross-sectional structure was measured by the following methods. First, a cross section was photographed by SEM-EDX (using JSM-6610A manufactured by Nippon Electronics Corporation) at an optical magnification of 300×, and image data of an observed image was obtained. This image data was input to an image analyzer (LUZEX_AP manufactured by Nireko Corporation), and the area of the phase present in the observed image was measured. As shown in FIG. 2, in the cross-sectional structure of the alloys for a sliding member, the relatively thin-colored layers relative to the matrices are Ni—Sn phases.

TABLE 4

| | | | | | | Ni-Sn | | |
|---|---|---|---|---|---|---|---|---|
| | | | | | | area | abrasion | |
| | | | | | | ratio | depth | frictional |
| | Cu | Sn | Ni | Bi | Ag | (%) | (mm) | coefficient |
| Experimental | Bal. | 5.1 | 6.0 | 1.8 | 0.01 | 0.3 | 9.7 | 0.113 |
| Example 1 | | | | | | | | |
| Experimental | Bal. | 9.0 | 3.1 | 3.8 | 0.14 | 0.7 | 8.6 | 0.092 |
| Example 1 | | | | | | | | |
| Experimental | Bal. | 8.9 | 6.2 | 4.0 | 0.14 | 1.9 | 8.0 | 0.098 |
| Example 1 | | | | | | | | |
| Experimental | Bal. | 8.1 | 6.0 | 1.9 | 0.01 | 0.9 | 7.5 | 0.11 |
| Example 1 | | | | | | | | |
| Experimental | Bal. | 5.8 | 1.1 | 2.7 | 0.09 | 0.1 | 11.5 | 0.163 |
| Example 1 | | | | | | | | |
| Experimental | Bal. | 10.0 | 6.1 | 2.1 | 0.29 | 1.5 | 8.0 | 0.1 |
| Example 1 | | | | | | | | |
| Experimental | Bal. | 8.0 | 5.3 | 1.6 | 0.21 | 0.4 | 8.7 | 0.125 |
| Example 1 | | | | | | | | |

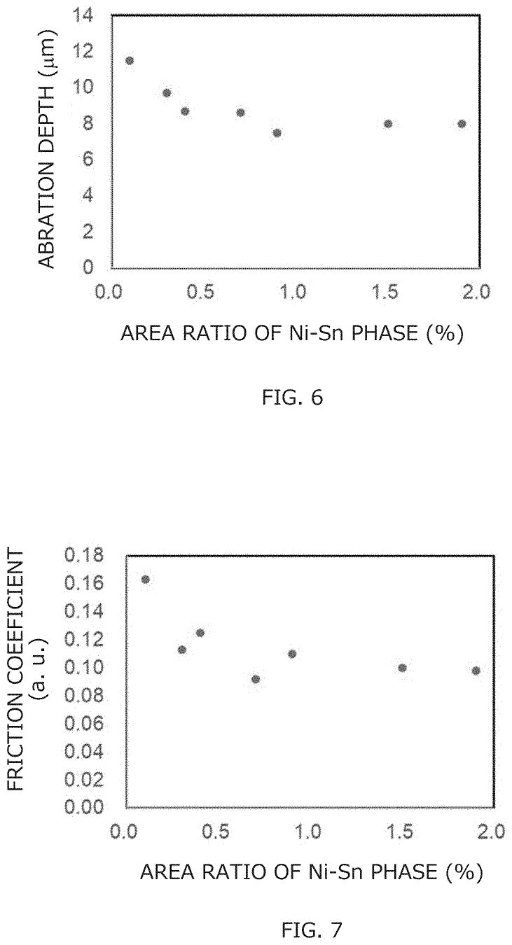

FIG. 6 is a graph showing the relationship between the area ratio of the Ni—Sn phase and the abrasion depth. The conditions of the abrasion test are as follows.

Test: block on ring

Load: 90 N

Rotating speed: 0.5 m/s

Time: 30 minutes

Oil type: paraffin oil

Oil temperature: room temperature

According to the experimental results, while the amount of wear is large while the area ratio of the Ni—Sn phase is low, the amount of wear decreases as the area ratio of the Ni—Sn phase increases, and the area ratio stabilizes at low levels from about 0.8% or more. From this result, the area ratio of the Ni—Sn intermetallic compound in the cross section is preferably 0.4% or more, and more preferably 0.8% or more.

FIG. 7 is a graph showing the relationship between the area ratio of the Ni—Sn phase and the frictional coefficient. According to the experimental results, while the friction coefficient is large when the area ratio of the Ni—Sn phase is low, the friction coefficient decreases as the area ratio of the Ni—Sn phase increases, and the area ratio stabilizes at levels lower than about 1.5%. From this result, the area ratio of the Ni—Sn intermetallic compound in the cross section is preferably 0.4% or more, and more preferably 1.5% or more. As a result of decreasing the coefficient of friction in this manner, when this material is used for a sliding member, for example, a bearing, effects of a suppressed rise in temperature at the time of high load and improved seizure resistance can be obtained.

What is claimed is:

1. An alloy for a sliding member, the alloy comprising:
5.5 to 10 mass % of Sn;
2 to 7 mass % of Ni;
1 to 5 mass % of Bi;
0 to 0.3 mass % of Ag; and
the balance consisting essentially of Cu and unavoidable impurities.

2. The alloy for a sliding member according to claim 1, wherein
the area ratio of Ni—Sn intermetallic compound in the cross section is 0.4% or more.

3. The alloy for a sliding member according to claim 1, wherein
in the cross section, Bi grains having an area of 30 μm² or more and Bi grains having an area of 5 μm² or less coexist.

4. The alloy for a sliding member according to claim 3, wherein
the ratio of the number of Bi grains having the area of 5 μm or less to the total number of Bi grains observed in the cross section is 50% or more.

5. The alloy for a sliding member according to claim 3, wherein
in an area with a radius of 25 μm whose center is located at the center of Bi grains having an area of 30 μm² or more, the ratio of specific Bi grains to the total number of Bi grains is 50% or more, the specific Bi grains being Bi grains having an area of 5 μ² or less.

6. A sliding member comprising:
a lining layer formed of an alloy for a sliding member according to claim 1; and
a resin coating layer or a metal plating layer formed on the lining layer.

7. An internal combustion engine comprising the sliding member according to claim 6.

8. A motor vehicle comprising an internal combustion engine according to claim 7.
